(19) United States
(12) Patent Application Publication
(10) Pub. No.: US 2026/0013422 A1
(43) Pub. Date: Jan. 15, 2026

(54) Method for Controlling the Smooth Running of a Coulter Unit

(71) Applicant: Amazonen-Werke H. Dreyer SE & Co. KG, Hasbergen (DE)

(72) Inventors: Christian HENKE, Brgwedelu (DE); Jens KOCH, Uelzen (DE)

(73) Assignee: Amazonen-Werke H. Dreyer SE & Co. KG, Hasbergen (DE)

(21) Appl. No.: 18/880,866

(22) PCT Filed: Jun. 6, 2023
(86) PCT No.: PCT/EP2023/065027

§ 371 Date: Jan. 3, 2025

(30) Foreign Application Priority Data
Jul. 6, 2022 (DE) 10 2022 116 842.5

(51) Int. Cl. A01C 7/20; A01C 5/06

(52) U.S. Cl. CPC A01C 7/205; A01C 5/064

(57) ABSTRACT

A method for controlling the smooth running of a coulter unit comprising a seed coulter, a running wheel, which, in order to generate a seed furrow, is pressed onto an agricultural area via the seed coulter with an adjustable coulter pressure onto an agricultural utilizable area and, via the running wheel, is moved at a travel speed over the agricultural utilizable area, wherein a coulter force acting on the coulter unit is measured.

### CROSS REFERENCE TO RELATED APPLICATIONS

The present application claims priority under 35 U.S.C. § 365 to PCT/EP2023/065027 filed on Jun. 6, 2023 and under 35 U.S.C. § 119 (a) to German Application No. 10 2022 116 842.5 filed on Jul. 6, 2022, both of which are incorporate by reference in their entireties.

### BACKGROUND

The disclosure relates to a method for controlling the smooth running of a coulter unit comprising a seed coulter, and preferably a running wheel, which is pressed onto an agricultural area with an adjustable coulter pressure via the seed coulter to generate a seed furrow, and, in particular via the running wheel, is moved at a travel speed over the agricultural utilizable area, wherein a coulter force acting on the coulter unit, in particular on the running wheel, is measured. A further subject of the disclosure is a sowing machine with a control for smooth running.

Coulter units are often used as components of sowing machines for spreading seed on agricultural land. Such sowing machines are usually driven at a certain travel speed along essentially parallel tracks over the agricultural land, for which purpose they are usually attached to or mounted on tractors, such as tractors.

At its rear end, a sowing machine usually comprises several coulter units arranged parallel to one another transversely to the direction of travel for depositing the seed in parallel seed rows. A coulter unit usually comprises a seed coulter for forming a seed furrow in the agricultural area. The seed coulter, which is usually in the shape of a chisel or cutting blade, is often subjected to a coulter pressure acting in the direction of the utilizable area in such a way that it forms a channel- or groove-like seed furrow extending behind the sowing machine in the direction of travel. The seed can be placed in this seed furrow, with the depth of the seed furrow determining the placement depth of the seed. For improved running, for example at higher travel speeds of the sowing machine, high-quality coulter units usually also comprise a running wheel on the utilizable area.

In order to ensure that the seed is placed at a uniform placement depth, sowing machines usually also comprise a coulter pressure control system, by means of which the coulter pressure acting on the coulter unit can be controlled. The regulation of the coulter pressure is often carried out in such a way that a pre-set placement depth of the seed, which depends on various factors, such as the seed or the properties of the utilizable area, is maintained as evenly as possible.

The coulter force acting on the coulter unit is usually used as the input variable for controlling the coulter pressure. Various concepts are known from the state of the art for determining the coulter force, such as direct, for example metrological, measurement of the coulter force acting between the utilizable area and the coulter unit at the running wheel.

In practice, it has been found that the smooth running of the coulter unit has an influence on the seed output, especially at high travel speeds-which are often desired in practice to achieve high area outputs—or with changing properties of the utilizable area. In the state of the art, therefore, coulter pressure control methods are known which take into account not only coulter force but also smooth running. For example, EP 3 732 947 A1 proposes the arrangement of acceleration sensors on the coulter unit, via which the smooth running can be recorded for inclusion in the coulter pressure control. In a similar way, it is known from US 2016/0165789 A1 to use acceleration sensors arranged on various components of a sowing machine to control the coulter pressure, in addition to a large number of other measuring sensors and probes. Here, the acceleration of the coulter unit is used as a controlled variable.

In practice, however, it has proven to be a disadvantage that the methods for controlling the smooth running or coulter pressure become comparatively complex when taking into account additional measured values in addition to the coulter force, such as acceleration data. Furthermore, the additionally required measuring sensors or probes, such as the acceleration sensors and their cabling, have proven to be susceptible to faults under the often harsh conditions of sowing in the wild.

### SUMMARY

Against this background, one object of the disclosure is to provide a method for controlling the smooth running of a coulter unit and a sowing machine with a smooth running control system which is configured simply and at the same time is not susceptible to faults.

The coulter force can be captured over a measuring interval to determine a coulter force curve over time and a bandwidth of the coulter force curve is used as a controlled variable to regulate the smooth running. Such a configuration enables the smooth running to be determined without additional sensors, which simplifies the method. Furthermore, the method also proves to be less susceptible to faults, as additional acceleration sensors can be dispensed with.

Preferably, several coulter units are arranged together on a swivel support extending transversely to the direction of travel, whereby the coulter units are pressed together with an adjustable coulter pressure onto the agricultural area by rotating the support. The coulter force acting on a coulter unit can be adjusted by rotating the support. A sowing machine can comprise several such swivel supports.

An advantageous configuration provides for the band width to be determined from the difference between a maximum coulter force and a minimum coulter force of the coulter force curve. Such a configuration enables reliable coverage of the entire spectrum of coulter forces occurring and efficient determination of the bandwidth on the basis of a simple calculation operation. In this context, it is advantageous that the bandwidth can be determined in an efficient manner on the basis of measured values of the coulter force already available and comprised over the measurement interval.

In addition, it is proposed that the smooth running is controlled via a control loop comprising a controlled system with the coulter pressure as the manipulated variable. Such a configuration enables a rapid adjustment of the smooth running during sowing and thus an effective adjustment of the smooth running to any changing conditions and circumstances during sowing. Furthermore, such a configuration enables reliable suppression of disturbing influences acting on the coulter unit.

In this context, it is proposed that a limit value of the bandwidth is used as a reference variable of the control loop, which is compared with the bandwidth to determine a control deviation. Such a configuration enables simple control as a function of the reference variable. In particular, by using the limit value of the bandwidth, it can be ensured that it is not exceeded during sowing. This can reduce the loads on the coulter unit resulting from excessively uneven running, for example as a result of vibrations. Furthermore, it can be ensured that sowing is impaired by excessively uneven running.

In an advantageous configuration in terms of control technology, the control deviation is fed to a controller in which a value of the coulter pressure is formed as a control variable. In this context, coulter pressure has been found to be a parameter that can be controlled in a structurally advantageous and simple manner. In particular, a fast-acting control of the smooth running can be made possible by adjusting the coulter pressure.

In an advantageous further variant, it is proposed that at least one parameter of the utilizable area and/or the travel speed and/or at least one coulter parameter are taken into account as disturbances. Such a configuration makes it possible in an advantageous way to take into account influencing variables acting on the smooth running when controlling the smooth running. The parameters of the utilizable area can be, in particular, the type and moisture of the soil. The coulter parameters can, for example, be structural features or a state of wear or abrasion of the seed coulter.

In an advantageous further variant of the method, it is proposed that a limit value of the coulter force and/or the travel speed be used as a condition, in particular for the controller. Such a configuration can ensure that neither the coulter force nor the travel speed are exceeded during sowing. By limiting the maximum coulter force, it can be ensured that a permissible mechanical load on the coulter unit is not exceeded. This can also reduce wear on the coulter unit, for example, which can increase the lifetime of the coulter unit. Furthermore, the advantage for selected seeds is that the soil is not reconsolidated too much, which favors emergence. On the other hand, it can also be advantageous to specify a minimum value for the coulter force, which must not be under-cut. By maintaining a minimum value for the coulter force, for example, the correct placement depth for the seed can be ensured. Limiting the travel speed can also prove to be advantageous in terms of wear on the coulter unit, as vibrations, for example, which can occur more frequently at higher travel speeds, can be reduced. Furthermore, by setting a maximum travel speed, uniform sowing of the seed on the utilizable area can be ensured.

In this context, it is proposed that the limit value of the bandwidth and/or the limit value of the coulter force are stored in a driving mode and are set by selecting the driving mode. Such a configuration enables a user-friendly, error-free setting of the limit values of the bandwidth and/or the coulter force by selecting the driving mode by the operating personnel, such as the driver of the tractor. For example, the type of sowing, properties and/or characteristics of the seed as well as parameters of the utilizable area, such as its soil quality, moisture or evenness, etc. can be stored in the driving mode.

In an advantageous further variant of the disclosure, different driving modes are proposed. The user-friendliness can be further increased by several driving modes to be selected. In particular, the selection from different driving modes allows the limit values of the bandwidth and/or the coulter force to be set quickly while avoiding operator errors.

In this context, it has proven to be advantageous if the coulter pressure is increased to improve smooth running if the bandwidth is greater than the bandwidth limit value and the coulter force is less than or equal to the coulter force limit value. This is a simple and reliable way of improving smooth running while at the same time maintaining the mechanical load capacity of the coulter unit and favoring emergence by avoiding excessive compaction.

In this context, it is proposed that a deceleration signal is generated to reduce the travel speed if the coulter force is greater than the limit value of the coulter force. Such a configuration can ensure that the coulter force actually acting on the coulter unit does not assume excessive values. This can prevent excessive mechanical stress on the coulter unit, which affects the lifetime of the coulter unit. In particular, such a configuration proves to be advantageous in terms of reducing wear. Furthermore, such a configuration can prevent an incorrect, in particular too deep, placement depth of the seed coulter due to excessive coulter force, which can lead to incorrect sowing of the seed on the utilizable area.

In this context, it is further proposed that the deceleration signal for reducing the travel speed be transmitted to a travel drive generating the travel speed and/or to an operating display. By transmitting the deceleration to the travel drive, an automated, fast-acting reduction of the travel speed can be achieved. Transmission of the deceleration signal to an operating display allows the operating personnel to intervene in a user-friendly manner and allows them to have a control option.

In a further advantageous variant of the disclosure, it is proposed that an acceleration signal be generated to increase the vehicle speed if the coulter force is less than the limit value of the coulter force and the bandwidth is less than the limit value of the bandwidth. This ensures that the travel speed, which is approximately predetermined by the driving mode, is always at a maximum, taking into account the disturbances, whereby the area performance of the sowing can be maximized.

In this context, it has been found to be advantageous if the acceleration signal for increasing the travel speed is transmitted to the travel drive generating the travel speed and/or to the operating display. By transmitting the acceleration signal to the travel drive, an automated, fast-acting increase in the travel speed can be achieved to increase the area performance. Transmission of the acceleration signal to an operating display allows the operating personnel to easily and conveniently intervene in a user-friendly manner and allows them to have a control option.

It is suggested that a cache memory be provided in which the coulter force curve is stored. Such a cache memory enables a quick and efficient analysis of the stored coulter force curve. In particular, a cache memory enables quick access to the measurement data of the coulter force curve, which can improve the response time of the control system. Preferably, the coulter force curve is stored in the cache memory together with a GPS signal so that the data can be accessed again when working in alternating modes, for example for comparison.

It has also been found to be advantageous to set the measuring interval. Such a configuration has proven to be particularly computationally efficient because the measuring interval can be adapted to the respective measuring conditions. In particular, it may be preferable in this context to set the shortest possible measuring interval in order to obtain a control of smooth running that is particularly well adaptable to changing conditions. Alternatively, it may also be preferable to set a long measurement interval in order to capture the bandwidth of the coulter force curve over a longer period of time.

In this context, a further interference filter is proposed for filtering out interference signals from the coulter force curve. Such an interference filter allows a reliable avoidance of incorrect control. In particular, such an interference filter can be used to reliably filter excessively increased or decreased coulter force values out of the coulter force curve. Such coulter force values that are excessively increased or reduced in the manner of force peaks can result, for example, from driving over obstacles present on the utilizable area, such as stones, unevenness or the like.

In an advantageous further variant of the disclosure, it is proposed that the coulter force be measured by means of a force sensor arranged on the running wheel, in particular on the rotation axis of the running wheel. Such a configuration of the force sensor allows for a particularly accurate measurement of the coulter force acting on the coulter unit. Reliable determination of the coulter force is a basic requirement for efficient and fast control of smooth running.

In addition, it is proposed that the placement depth of the seed coulter be adjusted via its position in relation to the running wheel. Such a configuration enables a particularly simple and user-friendly rough presetting of the placement depth of the seed coulter. In particular, the placement depth of the seed coulter can thus be adapted in an advantageously quick and simple manner to different rough specifications of the placement depth. Such a rough specification of the placement depth may result, for example, from the type of seed or from the properties of the utilizable area.

In a further advantageous variant of the disclosure, it is proposed that the running wheel is arranged behind the seed coulter in the direction of travel. Such a configuration has proven to be advantageous from a structural point of view with regard to good guidance of the coulter unit on the utilizable area, especially at high travel speeds. In this context, it is particularly preferred if the running wheel is arranged coaxially behind the seed coulter in the direction of travel. Alternatively, a running wheel is conceivable that is arranged in front of or next to the seed coulter.

With regard to efficient coulter pressure adjustment, it has proven to be advantageous if the coulter unit is pivoted about a pivot axis to adjust the coulter pressure. Such a configuration has proven to be advantageous in terms of generating and adjusting the coulter pressure in a reliable manner that is not susceptible to faults. In particular, it may be preferred in this context that the pivot axis extends transversely to the direction of travel.

In this context, it is further proposed that a swivel support extending along the swivel axis is provided, on which one or more coulter units are arranged. The coulter pressure can be adjusted in a structurally advantageous and simple manner by swiveling the swivel support about the swivel axis. Such a configuration allows simultaneous, uniform adjustment of the coulter pressure on several coulter units if these are arranged in segments on the swivel support. If several coulter supports are provided, on each of which a single coulter unit or a group of coulter units is arranged, the independent swiveling of the swivel supports can also be used to set different coulter pressures if this is found to be advantageous in the respective application. In this context, it has proven to be structurally and kinematically advantageous if the swivel support is rotated about the swivel axis to adjust the coulter pressure.

In this context, it is also preferable if the swivel support is rotated via a hydraulic drive. Such a configuration has proven to be particularly user-friendly. Furthermore, a uniform and fast-acting coulter pressure generation can be achieved via a hydraulic drive.

To solve the above-mentioned object, a sowing machine for spreading seed with several coulter units is also proposed, each comprising a seed coulter for generating a seed furrow in an agricultural area, and preferably a running wheel, via which the coulter units can be moved at a travel speed on the agricultural area, with force sensors for measuring a coulter force acting on the coulter units, in particular on the running wheels, and a control unit for controlling the smooth running of the coulter units, in which the smooth running is controlled in accordance with one or more of the features described above. The advantages described in connection with the method for regulating the smooth running of a coulter unit are achieved.

### BRIEF DESCRIPTION OF THE DRAWINGS

Further details and advantages of a method according to the disclosure for regulating the smooth running of a coulter unit and of a sowing machine according to the disclosure are explained below with the aid of the attached drawings according to FIGS. 1 to 5, which are briefly described below:

FIG. 1 shows a perspective view of a sowing machine with several coulter units attached to an agricultural tractor;

FIG. 2 shows a schematic view of an exemplary coulter force curve;

FIGS. 3, 4 show perspective views of a coulter unit, and

FIG. 5 shows a block diagram of a method for controlling the smooth running of a coulter unit.

### DETAILED DESCRIPTION

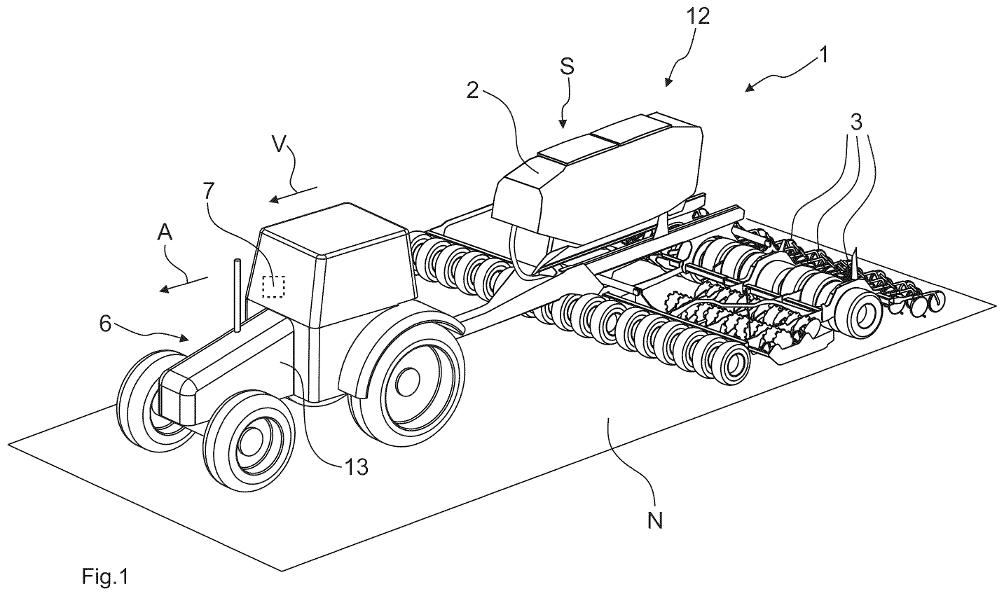

The illustration in FIG. 1 shows a sowing machine 1 for sowing seed S on an agricultural area N, for example a field or field for growing grain. In addition to or as an alternative to seed S, another grainy, powdery or granular material, such as a fertilizer or the like, can also be spread with such a sowing machine 1.

The sowing machine 1 is attached to a tractor 13, according to FIG. 1 a tractor, and is pulled over the agricultural area N at a certain travel speed V along paths running essentially parallel to each other in the direction of travel A in order to spread the seed S. Alternatively, the sowing machine 1 can also be attached to the tractor 13 or be configured to be self-propelled, for example as a robot or robot with integrated sowing machine. The seed S is stored in a large-volume, tank-like storage container 2 during spreading or sowing. The sowing machine 1 is a sowing machine 1 for volume sowing. However, it can also be another sowing machine 1, such as a machine for single-seed sowing.

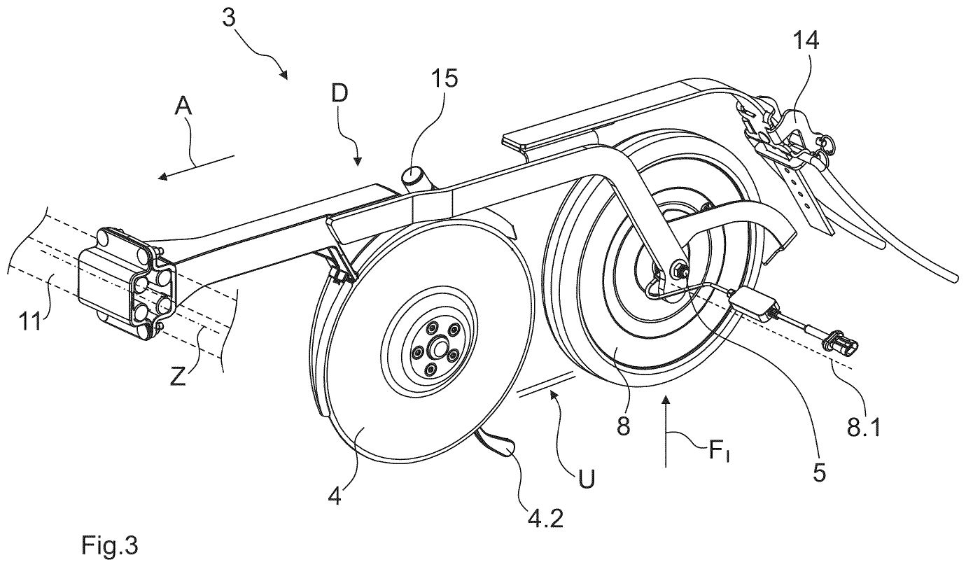

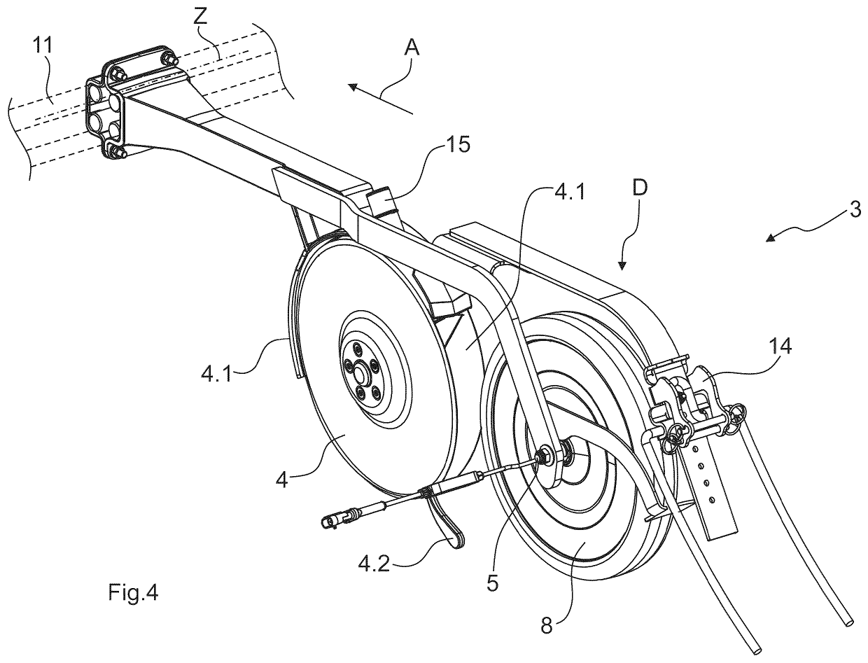

In addition to various other tools, devices or apparatus for soil cultivation, in particular for preparing the utilizable area N for sowing, the sowing machine 1 comprises numerous coulter units 3 arranged parallel to one another at its rear end. The coulter units 3 are used to deposit the seed S stored in the storage container 2 in parallel seed rows in the utilizable area N. In each case, a coulter unit 3 comprises a seed coulter 4 for generating a seed furrow U. As shown in FIG. 3, the seed coulter 4 is configured as a double-disc seed coulter and comprises two chisel-like, plate-shaped cutting disks 4.1. The cutting disks 4.1 are aligned at an angle to each other, in particular in a V-shape, rotatably mounted on the coulter unit 3 and are pressed onto the utilizable area N via a coulter pressure actuator with a coulter pressure D acting perpendicular to the utilizable area N. This causes the cutting disks 4.1 to cut into the soil and generates a groove-shaped seed furrow U extending behind the coulter unit 3, the depth of which determines the placement depth T of the seed S. Alternatively, the seed coulter 4 may comprise only one cutting disk 4.1. The seed S, which can be fed from the storage container 2 for example via a pneumatic conveyor line 15, is deposited in the formed seed furrow U, which is not shown in the figures, see FIG. 4. The utilizable area N is post-processed via a seed press 4.2 and a two-pronged harrow 14 arranged at the rear end of the coulter unit 3 after the seed S has been deposited in the seed furrow U, see FIG. 14.

A running wheel 8 is arranged in the direction of travel A behind the seed coulter 4, over which the coulter unit 3 runs over the utilizable area N, see FIG. 4. Alternatively, constructions are also conceivable in which such a running wheel 8, also known as a depth guide roller, is dispensed with and the coulter unit 3 runs over the utilizable area N without a running wheel 8.

In order to ensure a uniform placement depth T of the seed S, the sowing machine 1 comprises a control unit 12, not shown in the figures, with a coulter pressure control R, via which the coulter pressure D acting on the coulter unit 3 can be controlled. The coulter force F acting on the coulter unit 3 is used as the input variable for the coulter pressure control R. The respective actual or measured value of the coulter force F_{I} is measured via a force sensor 8.1 arranged on the running wheel 8 and transmitted to the coulter pressure control R. Alternatively, the coulter force F_{I} can also be determined or ascertained in other ways, for example via a sensor arranged at a different location or by indirect determination at the coulter pressure actuator.

In order to achieve an area output that is as high as possible, it is desirable in practice to drive the sowing machine 1 over the utilizable area N at a travel speed V that is as high as possible. However, a higher travel speed V is often accompanied by a lower smooth running L, which can have an unfavorable effect on the longitudinal distribution of the seed S in the seed furrow U and can lead to increased mechanical loads on the coulter unit 3 and/or other components of the sowing machine 1. For this reason, the sowing machine 1 comprises a control of the smooth running L of the coulter unit 3, via which the smooth running L can be controlled to achieve the smoothest possible running of the coulter unit 3.

In the case of the sowing machine 1, the smooth running L is detected without additional sensors, such as acceleration or vibration sensors, which simplifies the corresponding method for controlling the smooth running L. Furthermore, the method also proves to be less susceptible to faults due to the lack of additional sensors and their cabling, which will be explained in detail below.

The basis of the method for controlling the smooth running L is the capture of the coulter force curve W and the determination of the bandwidth B_{I} of this coulter force curve W. The coulter force F_{I} measured via the force sensor 8.1 is captured over a measuring interval I to determine the coulter force curve W over time and a bandwidth B_{I} of the coulter force curve W is used as a controlled variable or as a feedback variable for controlling the smooth running L, which will be explained in more detail below.

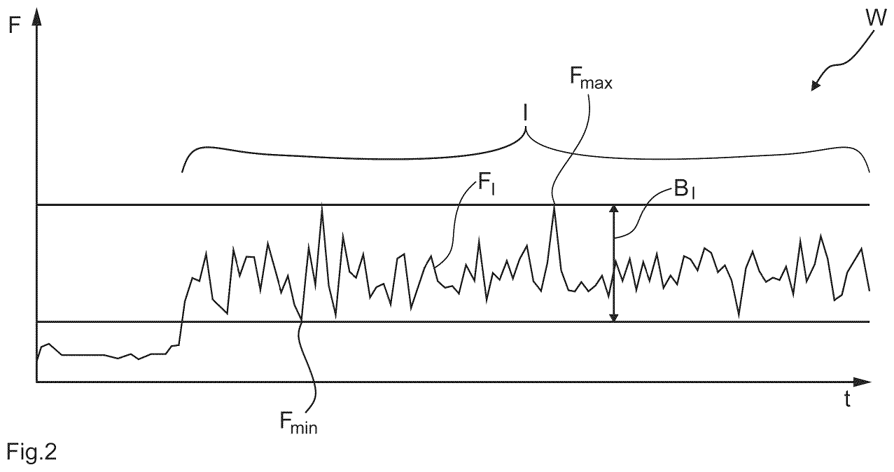

First, however, the illustration of an exemplary coulter force curve W as shown in FIG. 2 is used to explain how the actual value of the bandwidth B_{I} is determined.

FIG. 2 shows the course of the coulter force F_{I} acting on a coulter unit 3 over time t. At the beginning, i.e. shortly after the time t=0, the sowing machine 1 is raised in the so-called headland for maneuvering the tractor 13, so that the coulter units 3 do not touch the utilizable area N. During this phase, the coulter force F_{I} is accordingly at a low level, which should not be included in the capture of the bandwidth B_{I} so as not to impair the control of the smooth running L. The measuring interval I for capturing the bandwidth B_{I} only begins when the coulter units 3 are placed on the utilizable area N and sowing begins. From this point onwards, the coulter force F_{I} fluctuates during sowing between a minimum coulter force Fₘᵢₙ and a maximum coulter force Fₘₐₓ. The fluctuation of the coulter force F_{I} results, for example, from vibrations or shocks of the coulter unit 3 or other components of the sowing machine 1 or, for example, the property of the utilizable area N, such as unevenness, surface roughness, areas with varying moisture or different penetration resistances of the seed coulter 4 into the utilizable area N. The fluctuation of the coulter force F_{I} reflects the smooth running L of the coulter unit 3. In a hypothetical completely smooth running of coulter unit 3 on utilizable area N, the coulter force F_{I} would be at a uniform level over time t. The bandwidth B_{I} serves as a measure for the fluctuations of the coulter force F_{I} occurring in actual sowing operation during sowing, and thus for the smooth running L. It is determined from the difference between the maximum coulter force Fₘₐₓ occurring in the measuring interval I and the minimum coulter force Fₘᵢₙ measured in the same measuring interval, see FIG. 2. The bandwidth B_{I} can also be referred to as the amplitude of the coulter force F_{I} or the coulter force curve W. Alternatively or additionally, other parameters of the coulter force curve W, such as the frequency of the fluctuations of the coulter force F_{I}, can be used as a measure or parameter for the smooth running L.

The measuring interval I is set and can be adjusted in terms of its duration. A shorter measuring interval I, after which the smooth running L is adjusted, may be preferred in order to allow control that is as good as possible and sensitive to changing conditions. Alternatively, a longer measuring interval I, over which the coulter force curve W is recorded, can also be advantageous if the respective sowing situation, in particular the properties of the seed S, the sowing machine 1 or the utilizable area N, allow this.

The coulter force curve W is temporarily stored in a cache memory 9, see FIG. 2. The storage capacity of the cache memory 9 can be adapted to the maximum length of the adjustable measuring interval I. Furthermore, an interference filter 10 is provided for filtering out interference signals from the coulter force curve W. The interference filter 10 can be used to filter out spikes or peaks in the measured coulter force F_{I}, which can result from the passage of a stone lying on the utilizable area N or similar and can strongly influence the amounts of the maximum coulter force Fₘₐₓ or the minimum coulter force Fₘᵢₙ. In this way, these irregularly occurring interference signals are not used to determine the bandwidth B_{I}, so that its value is not distorted. Alternatively or additionally, other filters can also be provided for filtering out interference signals from the coulter force curve W if it is found that such interference signals influence the control of the smooth running L.

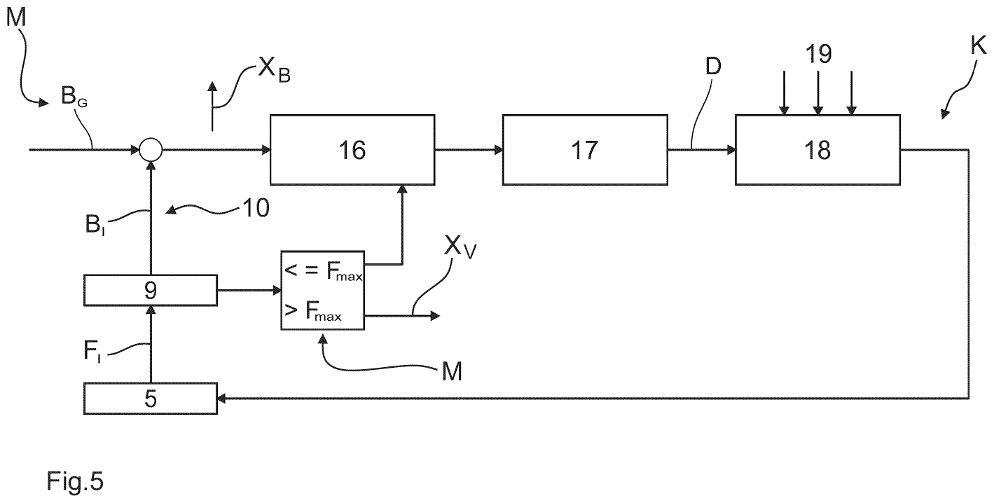

The above-described determination of the bandwidth B_{I} from the measured coulter force curve W stored in the cache memory 9 forms the basis for controlling the smooth running L. The smooth running L is controlled via a control loop K, which is shown schematically as a block diagram in FIG. 5. The method for controlling the smooth running L is explained below using the illustration in FIG. 5.

A limit value B_{G} of the bandwidth B is used as the reference variable of the control loop K. This specified limit value B_{G} of the bandwidth B is compared with the measured actual value of the bandwidth B_{I} to determine the control deviation. The control difference determined by the comparison between the reference variable, i.e. the limit value B_{G} of the bandwidth, and the feedback variable, i.e. the actual bandwidth B_{I}, is fed to a controller 16. The controller 16 is used to form the control variable of the control loop K, which in the present case is a value of the coulter pressure D. As an additional condition for the controller 16, a limit value F_{G} of the coulter force F and/or a limit value of the travel speed V is preset. Furthermore, depending on the equipment of the sowing machine 1 and the respective sowing situation, further conditions are conceivable which can be preset for the controller 16.

In the method for controlling the smooth running L, the coulter pressure D is increased to improve the smooth running L if the actual bandwidth B_{I} is greater than the limit value B_{G} of the bandwidth B and the coulter force F_{I} is less than or equal to the limit value F_{G} of the coulter force F. This means that the coulter pressure D is only increased to improve the smooth running L if the measured value B_{I} of the bandwidth B exceeds the specified limit value B_{G} of the bandwidth B. As a boundary condition for a possible increase in coulter pressure D, the mean value of coulter force F_{M}, which is determined as the average value of coulter force F_{I} from the coulter force curve W measured via force sensor 5 over a measuring interval I, must not exceed a preset limit value F_{G} of coulter force F. The purpose of presetting a limit value F_{G} of the coulter force F is to keep the mechanical load on the sowing machine 1 and in particular the coulter unit 3 within a safe range in which no damage and above all no failure is to be expected. In addition, the emergence of the seed is favored.

If the mean value F_{M} of the coulter force exceeds the limit value F_{G} of the coulter force, the coulter pressure D is no longer increased. Instead, a deceleration signal X_{V} is generated to reduce the travel speed V. This deceleration signal X_{V} is transmitted to a travel drive 6 that generates the travel speed V in order to reduce the travel speed V. The travel drive 6 is the travel drive of the tractor 13. A reduction of the travel speed V is automatically initiated in the travel drive 6 on the basis of the deceleration signal X_{V}. Alternatively or additionally, the deceleration signal X_{V} can be transmitted to an operating display 7 configured in the manner of a screen, which can be viewed by the driver of the tractor 13. The driver of the tractor 13 can be prompted to reduce the travel speed V by a corresponding message or an error message on the operating display 7, which can be provided in particular for more simply equipped tractors 13 without an automatically controlled travel drive 6.

If the mean value F_{M} of the coulter force is less than the limit value F_{G} of the coulter force F and the measured bandwidth B_{I} is less than the limit value B_{G} of the bandwidth B, an acceleration signal X_{B} for increasing the travel speed V is generated. Depending on the equipment of the tractor 13, this acceleration signal X_{B} is transmitted for automatic acceleration to the travel drive 6 generating the travel speed V and/or to an operating display 7 visible to the driver or the operating personnel of the tractor 13, whereupon the driver can increase the travel speed V manually.

On the controlled system 18, various disturbances 19 act on the coulter pressure D value formed in the controller 16. These can be, for example, parameters of the utilizable area N, such as its soil moisture, penetration resistance, unevenness or roughness or other properties. Furthermore, the travel speed V of the sowing machine 1 can also be such a disturbance 19. In addition, parameters of the seed coulter 4, such as structural features, its state of wear or special equipment, can be taken into account as disturbances 19.

The limit value B_{G} of the bandwidth B and the limit value F_{G} of the coulter force F are stored in a driving mode M of the sowing machine 1. These are, for example, empirically determined empirical values which are stored in different driving modes M for certain conditions, such as the type or property of the seed S, the property of the utilizable area N or the soil preparation before sowing (i.e. whether it is plough sowing, mulch sowing or direct sowing). The corresponding driving mode M can be selected and set by the operator. Alternatively, automatic setting of the driving mode M or the limit values B_{G}, F_{G}, V or similar is also conceivable.

As already explained above, the currently acting coulter force F_{I}, i.e. the contact force of the coulter unit 3 on the utilizable area N, is measured via the force sensor 5 arranged on the rotation axis 8.1 of the running wheel 8. The measured value of the coulter force F_{I} is fed back and temporarily stored in the cache memory 9, which comprises a computer, as a coulter force curve W for the set measuring interval I. By evaluating the coulter force curve W, a new measured value B_{I} of the bandwidth B is determined, which is fed back as a new feedback variable for comparison with the limit value B_{G} of the bandwidth B. The control loop K is passed through again.

In the following, the diagrams in FIGS. 3 and 4 are used to explain the generating and adjustment of the coulter pressure D acting on the coulter unit 3. According to the schematic representation of the smooth running control L in FIG. 5, the coulter pressure D is generated in the coulter pressure system 17. As can be seen from the illustration in FIG. 3, the coulter unit 3 is pivotably mounted about a pivot axis Z extending transversely to the direction of travel A in order to generate the coulter pressure D. A swivel support 11, not shown in the figures and configured in the form of a profile or tube, extends along the swivel axis Z, to which several coulter units 3 arranged parallel to each other are elastically hinged via the bearing elements so that they can be rotated. By rotating the swivel support 11 about the swivel axis Z, the coulter pressure D acting on the coulter units 3 connected to it can be adjusted. Depending on the angle of rotation around the swivel axis Z, different amounts of coulter pressure D can be set. A hydraulic drive is provided to drive the rotary movements of the swivel support 11. Alternatively, this can also be a different drive. For example, the coulter pressure D value generated in the controller 16 can be set via the generating of the coulter pressure D described above. A higher value of the coulter pressure D can thereby cause a deeper penetration of the cutting disks 4.1 of the seed coulter 4 into the utilizable area and thus a deeper seed furrow U, whereby a greater placement depth T for the seed S can be set. In addition to the method described above for generating the coulter pressure D via the rotation of the swivel support 11, other methods are also conceivable, such as the arrangement of coulter pressure actuators directly on the coulter unit 3 or the seed coulter or the like.

The running wheel 8, which runs on the utilizable area N, is arranged coaxially behind the seed coulter 4 in the direction of travel A. A rough presetting of the placement depth T for the seed S can be set via the relative positioning of the running wheel 8 with respect to the seed coulter 4, in particular in the vertical direction. Fine adjustment of the placement depth T is achieved by tilting the seed coulter 4.

The method described above for controlling the smooth running L and the sowing machine 1 with a control of the smooth running L are characterized by the fact that the detection of the smooth running L is possible in a simple manner without additional sensors. Furthermore, the method and the sowing machine 1 also prove to be less susceptible to faults, as additional acceleration sensors can be dispensed with.

### REFERENCE SIGNS

1 Sowing machine
2 Storage container
3 Coulter unit
4 Seed coulter
4.1 Cutting disk
4.2 Seed press
5 Force sensor
6 Travel drive
7 Operating display
8 Running wheel
8.1 Rotation axis
9 Cache memory
10 Interference filter
11 Swivel support
12 Control unit
13 Tractor
14 Harrow
15 Conveyor line
16 Controller
17 Coulter pressure system
18 Controlled system
19 Disturbance
A Direction of travel
B Bandwidth
B_{I} Bandwidth, measured value
B_{G} Bandwidth, limit value
D Coulter pressure
F Coulter force
F_{G} Coulter force, limit value
F_{I} Coulter force, measured value
F_{M} Coulter force, mean value
Fₘₐₓ Maximum coulter force
Fₘᵢₙ Minimum coulter force
I Measuring interval
K Control loop
L Smooth running
M Driving mode
N Utilizable area
R Coulter pressure control
S Seed
T Placement depth
t Time
U Seed furrow
V Travel speed
W Coulter force curve
X_{B} Acceleration signal
X_{V} Deceleration signal
Z Swivel axis

1. MA method for controlling smooth running of a coulter unit comprising a seed coulter, and a running wheel, wherein the method comprises: pressing the running wheel via the seed coulter with an adjustable coulter pressure onto an agricultural area in order to generate a seed furrow, and moving the running wheel over the agricultural area at a travel speed, during which a coulter force acting on the coulter unit is measured, wherein the coulter force is captured over a measuring interval to determine a coulter force curve over time and a bandwidth of the coulter force curve is used as a controlled variable for controlling the smooth running.

2. The method according to claim 1, wherein the bandwidth is determined from the difference between a maximum coulter force and a minimum coulter force of the coulter force curve.

3. The method according to claim 1, wherein the smooth running is controlled via a control loop comprising a controlled system with the coulter pressure as manipulated variable.

4. The method according to claim 3, wherein a limit value of the bandwidth is used as a reference variable of the control loop, which is compared with the bandwidth to determine a control deviation.

5. The method according to claim 4, wherein the control deviation is fed to a controller in which a value of the coulter pressure is formed as a control variable.

6. The method according to claim 1, wherein at least one parameter of the utilizable area and/or the travel speed and/or at least one coulter parameter are taken into account as disturbances.

7. The method according to claim 1, wherein a limit value of the coulter force and/or the travel speed are used as a condition for the controller.

8. The method according to claim 1, wherein the limit value of the bandwidth and/or the limit value of the coulter force are stored in a driving mode and are set by selecting the driving mode.

9. The method according to claim 1, wherein the coulter pressure is increased to improve the smooth running if the bandwidth is greater than the limit value of the bandwidth and the coulter force is less than or equal to the limit value of the coulter force.

10. The method according to claim 1, wherein a deceleration signal for reducing the travel speed is generated if the coulter force is greater than the limit value of the coulter force.

11. The method according to claim 1, wherein an acceleration signal for increasing the travel speed is generated if the coulter force is smaller than the limit value of the coulter force and the bandwidth is smaller than the limit value of the bandwidth.

12. The method according to claim 1, wherein the coulter force curve is cached in a cache memory.

13. The method according to claim 1, wherein the measuring interval is set.

14. The method according to claim 1, wherein the coulter force is measured via a force sensor arranged on a rotation axis of the running wheel.

15. The method according to claim 1, wherein the coulter unit is swiveled about a swivel axis to adjust the coulter pressure.

16. The method according to claim 15, wherein the coulter unit further comprises a swivel support extending along the swivel axis, on which one or more coulter units are arranged.

17. A Sowing machine for spreading seed with several coulter units, each coulter unit comprising a seed coulter for generating a seed furrow in an agricultural utilizable area, a running wheel, via which the coulter units are movable at a travel speed on the agricultural utilizable area, force sensors for measuring a coulter force acting on the coulter units, and a control unit for controlling the smooth running of the coulter units,
wherein the smooth running is controlled in accordance with the method of claim 1.

18. The sowing machine of claim 17, wherein the force sensors measure a coulter force acting on the running wheels.
